(19) United States
(12) Patent Application Publication
(10) Pub. No.: US 2012/0098275 A1
(43) Pub. Date: Apr. 26, 2012

(54) PLANT FOR RE-GASIFICATION OF LIQUEFIED NATURAL GAS AND LIQUEFIED PETROLEUM GAS IN COMBINATION WITH PRODUCTION OF ELECTRIC POWER

(75) Inventors: Kåre Syvertsen, Tveit (NO); Bjørn Egil Gustavsen, Bjorbekk (NO)

(73) Assignee: SEVAN MARINE ASA, Arendal (NO)

(21) Appl. No.: 13/319,730

(22) PCT Filed: May 11, 2010
(86) PCT No.: PCT/NO10/00174

§ 371 Date: Dec. 27, 2011

(30) Foreign Application Priority Data
May 14, 2009 (NO) 2009 1902

(51) Int. Cl. H02K 7/18

(52) U.S. Cl. 290/1 R

(57) ABSTRACT

A plant for the combined re-gasification of refrigerated liquid gas and the production of electric power, where both a unit for re-gasification of liquid gas and a unit for the production of electric power are installed on board a floating terminal comprising tanks for liquid gas, said power producing unit being designed for the generation of electric power by combustion of hydrocarbons, and that the heat produced by the power producing unit is used for the re-gasification of the refrigerated liquid gas.

The present invention is directed to a floating plant for re-gasification of liquefied natural gas (LNG) and liquefied petroleum gas (LPG) in combination with the production of electric power.

Electric power is generated by combustion of re-gasified liquid gas. The produced heat during the generation of electric power is to be used for heating and vaporization of liquid refrigerated gas. The combination of the re-gasification of liquid gas and the production of electric power gives the possibility to establish a plant or station having a high efficiency and no disposal of cold or warm water to the environment.

Today many regions have rigorous requirements for the spill of heated or cooled water. As an example there is in certain areas a requirement that not more than four degrees temperature increase or decrease being allowed.

The technology of today for re-gasification of liquid refrigerated gas is mainly based upon the use of seawater being circulated through heat exchangers, often partly direct against refrigerated gas and partly by using a cooling medium in a secondary circuit. All the heat supply is mostly from the seawater. This raises a demand of great seawater amounts if only minor temperature differences can be extracted from the water.

The generation of electric power based upon the combustion of hydrocarbons provides three main principles to be utilized:

1. The combustion in a steam boiler for the production of steam to be used for the drive of a steam turbine producing electric power. The differential pressure over the steam turbine is established by the condensing of the steam. It is then a question of great heat amounts to be disposed of, and the seawater will most often be used if such water is available.

2.The combustion in a gas turbine having an exhaust vessel (“combined cycle”) connected. The electric power is then generated partly from said gas turbine and partly from a steam turbine using steam produced from the exhaust vessel. The heat from the condensing of steam also here has to be disposed of.

3. The combustion in a gas turbine without any plant for steam production (“single cycle”). Initially there is no recovering of exhaust heat, but by installing an exhaust vessel, the heat from said vessel can be used directly for the heating of the refrigerated gas.

In the plant for re-gasification and the production of electric power, according to the invention, the generated heat by the production of the electric power is used for heating and vaporization of liquid refrigerated gas. The combination of the re-gasification of liquid gas and the production of electric power makes possible a plant having no effluent of cold or warm water to the environment.

A rather high efficiency is achieved with such a plant for the generation of electric power according to the present invention. The plant is defined through the features given in the patent claims.

All the three above described types of a plant for the production of electric power can be used in the combination with a plant for the gasification of refrigerated liquid gas. If steam turbines are installed, the heated cooling water from the condensing of steam will be heat exchanged with cold gas. In plants having a gas turbine, hot steam or hot water from the exhaust vessel will be heat exchanged directly with the cold gas.

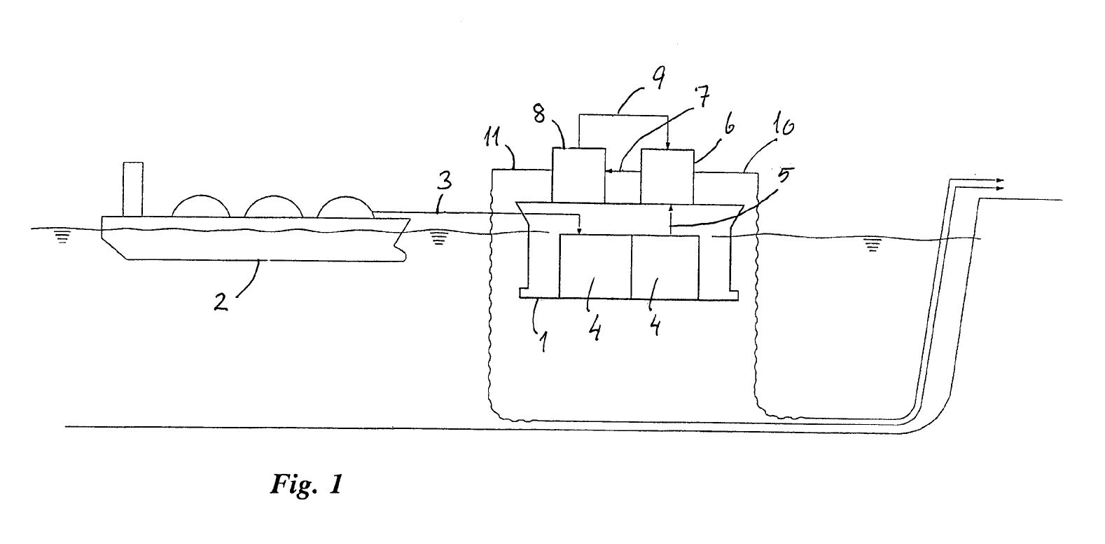

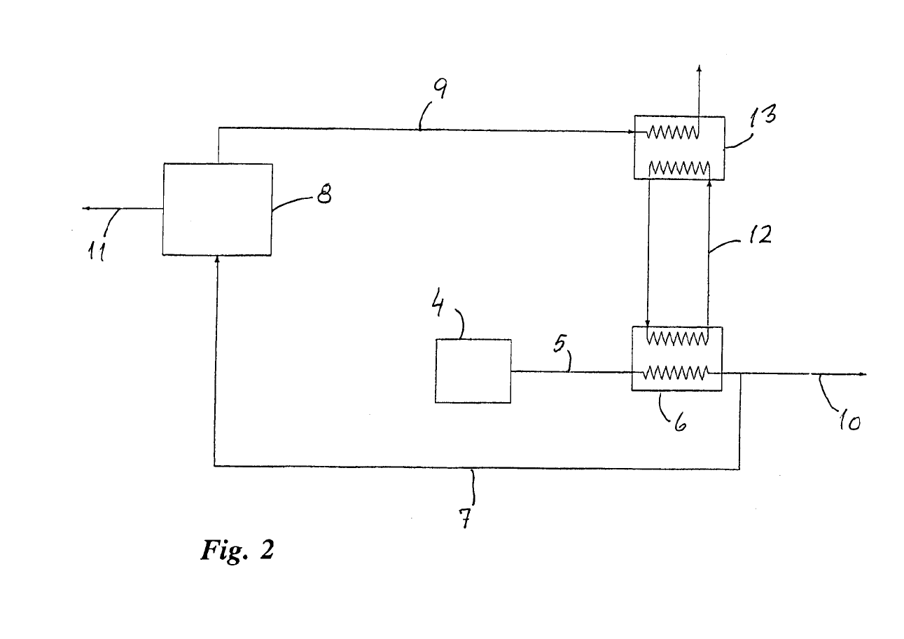

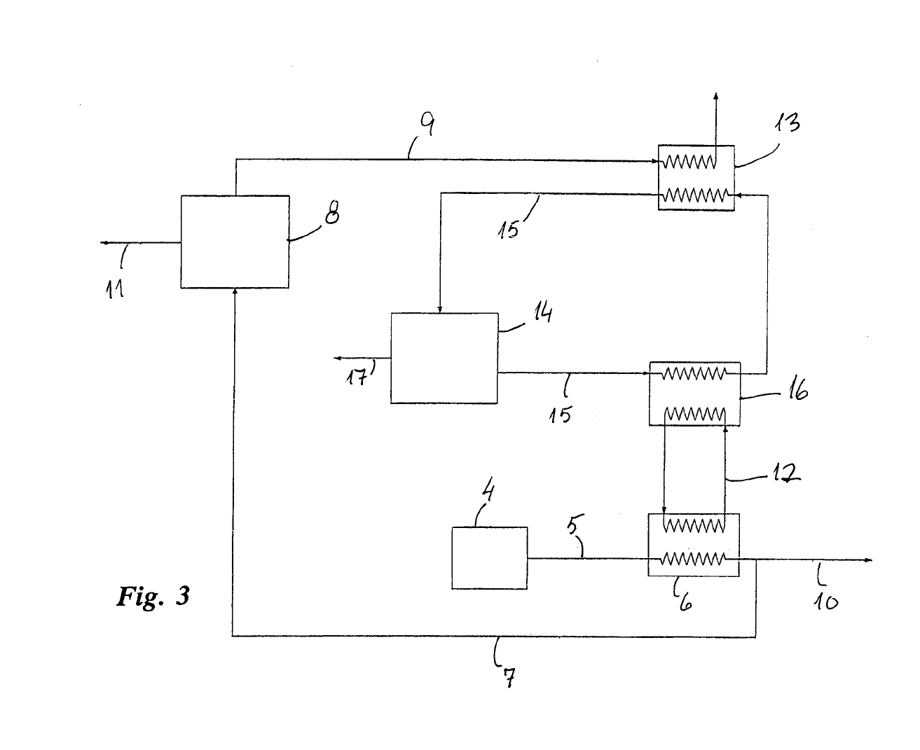

In the drawing FIG. 1 schematically and in a block diagram shows a plant for receiving LNG from a ship, FIG. 2 schematically and in a block diagram shows a plant for re-gasification according to a single cycle, and FIG. 3 shows schematically in a block diagram a plant for re-gasification and working in a double cycle. The plants are on board a floating terminal for the storing of liquid refrigerated gas.

The plant 1 receives, as shown in FIG. 1, LNG from a LNG ship 2 through a transfer line 3 and feeds the LNG to storage tanks 4 for such liquefied gas on board the plant. The gas 5 there from is transferred to the re-gasification plant 6 where it is heated to enter its gas phase, then pressurized and sent through flexible and rigid pipes 10 to land. Some of the gas 7 is transferred from the re-gasification plant 6 to the gas power station 8 (of the type “single cycle”, “combined cycle” or as a gas heated steam boiler). Heat 9 from the gas power station is transferred to the re-gasification plant 6 for the heating of the refrigerated gas. Electric power 11 generated in the gas power station 8 is transferred via cable to land.

Also in FIG. 2 is shown that liquefied gas 5 is transferred from the tanks 4 to the re-gasification plant 6 and there heated to go into its gas phase and is sent under pressure through the pipe line 10 to land. The gas is heat exchanged with a heating medium 12 in its turn heat exchanged with exhaust 9 from the gas power station 8 in a heat recovering plant 13. The gas power station 8 receives heat from the produced gas 7 and generates electric power 11 to be transferred to land by cable.

Also in FIG. 3 is shown that liquefied gas 5 is transferred from the tanks 4 to the re-gasification plant 6 and there heated to go into its gas phase and is sent under pressure through the pipe line 10 to land. The gas is heat exchanged with a heating medium 12 in its turn heat exchanged with steam 15 from the steam plant 14 in a condensing plant 16. The steam 15 for the steam plant 14 is produced in the heat recovering plant 13 by heat exchange with exhaust from the gas power station 8. The steam power station generates electric power 17 to be sent to land by cable. The gas power station 8 is heated with the produced gas 7, delivers exhaust to the heat recovering plant 13 and generates electric power 11 to be transferred to land by cable.

The heated gas is to be exported from the gas terminal through pipe lines 10 to consumers on land. By the installation on a floating terminal, the first part of the pipe line from said terminal and down to the sea bottom will be a flexible riser. The remaining part of the pipe line may be of a conventional type.

The produced electric power is to be exported from the terminal to consumers on land through a high voltage cable 11. If the terminal is floating the cable between it and the sea bottom has to be sufficiently flexible to absorb any movements the platform may have.

The floating unit is to be geostationary, which means that it will not rotate during varying wind and wave directions. This involves that gas can be transferred to the pipe line without the use of a high pressure gas swivel, and further the electric power may be transferred without the use of swivel slip-rings for high voltage.

The intake of liquid gas will be from LNG/LPG ships. The transfer from the ship to the terminal can either be carried out such that the ship moors to a dock or similar on the terminal and so that LNG can be transferred through loading arms or by the transfer through a flexible hose 3. In the latter case it is made possible to transfer gas from ships having dynamic positioning equipment DPE to keep their position, by using towing vessels, or to transfer from ships that are moored to a mooring arrangement and thereby keeping their position at a distance from the terminal.

1.-6. (canceled)

7. A plant for the combined re-gasification of refrigerated liquid gas and the production of electric power, wherein both a unit for re-gasification of liquid gas and a unit for production of electric power are installed on board a floating terminal comprising tanks for liquid gas, that the power producing unit is arranged for producing electric power by combustion of hydrocarbons, and that the heat produced by the power producing unit is used for the re-gasification of the refrigerated liquid gas.

8. A plant according to claim 7, wherein being configured for, upon demand, to absorb a limited amount or no heat from the sea water.

9. A plant according to claim 7, wherein being configured for receiving and storing liquid refrigerated gas from LNG/LPG ships.

10. A plant according to claim 7, wherein obtaining a high efficiency by utilizing excess heat from the gas power station for the re-gasification of refrigerating gas.

11. A plant according to claim 7, wherein being configured for the positioning near consumers of gas and electric power.

12. A plant according to claim 7, wherein enabling the transfer of high voltage electric power through electric cables permanently connected to said plant.

13. A plant according to claim 8, wherein being configured for receiving and storing liquid refrigerated gas from LNG/LPG ships.

14. A plant according to claim 8, wherein obtaining a high efficiency by utilizing excess heat from the gas power station for the re-gasification of refrigerating gas.

15. A plant according to claim 9, wherein obtaining a high efficiency by utilizing excess heat from the gas power station for the re-gasification of refrigerating gas.

16. A plant according to claim 8, wherein being configured for the positioning near consumers of gas and electric power.

17. A plant according to claim 9, wherein being configured for the positioning near consumers of gas and electric power.

18. A plant according to claim 10, wherein being configured for the positioning near consumers of gas and electric power.

19. A plant according to claim 8, wherein enabling the transfer of high voltage electric power through electric cables permanently connected to said plant.

20. A plant according to claim 9, wherein enabling the transfer of high voltage electric power through electric cables permanently connected to said plant.

21. A plant according to claim 10, wherein enabling the transfer of high voltage electric power through electric cables permanently connected to said plant.

22. A plant according to claim 11, wherein enabling the transfer of high voltage electric power through electric cables permanently connected to said plant.
